(19) United States
(12) Patent Application Publication
(10) Pub. No.: US 2008/0101455 A1
(43) Pub. Date: May 1, 2008

(54) Apparatus and method for multiple format encoding

(75) Inventor: Erik Scheelke, Cupertino, CA (US)

Correspondence Address: MORRISON & FOERSTER, LLP, 555 WEST FIFTH STREET, SUITE 3500, LOS ANGELES, CA, 90013-1024, US

(73) Assignee: Digital Deck, Inc., Redwood City, CA (US)

(21) Appl. No.: 11/589,273

(22) Filed: Oct. 25, 2006

(51) Int. Cl. H04N 11/04

(52) U.S. Cl. 375/240.01

(57) ABSTRACT

Another aspect of the present invention is directed to system and a method that encodes a single input media stream into two or more output media streams having one or more different encoding characteristics. In one embodiment, one of the encoding characteristics which is different in the two or more output streams is the bandwidth of the encoding. In another embodiment, the different characteristic is the format of the encoding. In yet another embodiment the different characteristic is the computational complexity of the encoding. In a further development, computations which are common to the encoding process in each format may be found. The common computations may be performed only once. Once the common computations are performed in the context of encoding a media stream to a first format, the results of the common computations may be saved and used for encoding the media stream in other formats.

### FIELD OF THE INVENTION

The present invention is generally in the field of electronics and specifically in the field of encoders of media and other data streams.

### BACKGROUND OF THE INVENTION

Digital media has gained popularity in recent years. This has created a need for devices that provide digital media signals based on analog media signals, or digital media signals of a different format. These devices are usually referred to as encoders.

Encoders usually connect to an analog cable and receive an analog media signal therefrom. The media may be audio, video or a combined audio/video stream. The encoders process the analog stream to produce a digital stream that represents the same media. Alternatively, encoders may receive a digital signal encoded in a first digital format and re-encode the digital signal into a second digital format.

Video output devices, such as television screens and computer monitors are usually based on pixels. That is, they create images by illuminating many small dot-like areas on a screen (pixels) with predefined colors and brightness parameters. An encoded media signal must specify these color and brightness parameters. Some types of screens (such as, for example, LCD screens) have a specific predefined number of pixels, and therefore require that the media to be displayed on those screens is tailored to that number. This predefined number of pixels of a screen is also referred to as a screen's native resolution. Other types of screens (such as for example, CRT screens) feature the ability to change between different modes having different resolutions.

Many encoded video signals do not directly specify the brightness and color of each pixel, doing so requires large amounts of data. Instead, encoded video signals are usually compressed. Compression takes advantage of patterns and repetitions in video signals to create an encoded video signal that is smaller in size, than would be required if the color of each pixel in each frame were explicitly defined. Compression is performed according to predefined mathematical algorithms. There are also predefined algorithms to uncompress (or decode) a compressed stream, so that actual values for the brightness and color of each pixel may be obtained. Therefore, compressed video streams are usually specifically targeted to the number of pixels featured by the screen on which they are played.

There are some output devices that can display media encoded for a different number of pixels than featured by the output device by reprocessing the media or displaying the media in a ‘window’ different than the output device's screen. However, using these methods usually results in inferior video.

For the above discussed reasons, most current encoders encode streams for a particular resolution that is set with reference to the output device on which the encoded stream is to be used. Many encoders offer the ability to vary the encoding resolution, i.e. encode different streams at different resolutions at different times. However, these encoders still encode each particular stream at a single resolution only.

There are other parameters that are relevant to the encoding as well. One such parameter is the bandwidth of the encoding. The bandwidth is especially relevant in real time streaming scenarios in which the output device displays a media signal as it is receiving it. The bandwidth is usually defined as the amount of data that is necessary to encode a particular time interval of the media. For example, for a video stream, a bandwidth of 100 Kb/s signifies that 100 Kb are necessary to encode a second of video.

For many encoding formats the bandwidth of encoded video varies based on the information density of the video itself. In other words, busy and fast changing video portions often require higher bandwidths than slower and static video portions of the same video stream. To put it more generally, different portions of a media stream include different content which by its intrinsic qualities may be suitable for different levels of compression during encoding. And since different portions of the media stream are compressed at different levels during encoding, the encoded stream would consequently include portions of varying bandwidths.

However, many other encoding formats include features that allow encoders to keep the bandwidth of the encoded stream relatively constant by varying other aspects of the encoding process to compensate for the varying “business” of the stream. In other words, more busy portions of a stream are encoded at inferior quality in order to compensate for the decreased ability to compress these portions. And even variable bandwidth encoding algorithms usually allow an upper limit to be set

Another parameter relevant for encoding is the computational requirements of the decoding step. Many output devices have limited decoding ability. Some output devices use application specific integrated circuits (ASICs) that are specific to a certain encoding format, and therefore they may only decode streams encoded in that particular format. In addition, some output devices have limited computational ability and therefore may not decode streams that are encoded in a very complex manner.

There exist various encoding schemes, each associated with a respective encoding format. Examples of video encoding formats are MPEG 1, AVI, MPEG 4, H.263 and H.264/MPEG 4 AVC. Many of these formats may encode streams at multiple resolutions. Furthermore, many of these formats allow for varying the other parameters of the encoded stream, such as bandwidth and computational requirements for the decoding step. For example, the H.264/MPEG 4 AVC format includes multiple profiles and levels which specify different bandwidths and encoding/decoding complexities. Generally, the present description uses the term “format” to refer to the various “top level” formats such as MPEG 1, AVI, MPEG 4, etc. as well as the variations within these top level formats, which are related to different resolutions,. bandwidths, encoding decoding complexities, etc.

Due to the sophistication of existing compression schemes, encoding is often a computationally intensive process. As a result, encoding usually requires hardware that is relatively expensive. There is a relationship between the cost and sophistication of hardware and the time required to perform encoding for a particular format. More expensive and sophisticated hardware usually results in shorter encoding times, while cheaper hardware often requires longer encoding times. Encoding times have had increasing significance with the increasing consumer popularity of digital video. Consumers are generally dissatisfied with having to wait for long encoding times.

If a video stream can be encoded at about the same time it takes to play the video stream, then real time encoding is possible. That means that encoding of certain portions of the video stream may be performed as earlier portions of the video stream are played. Thus, a user watching the video stream will experience negligible wait times for encoding.

However, most modern high quality encoding algorithms are relatively complex, and consequently encoding on available hardware usually takes longer. Therefore, for most high quality video streams the encoding takes longer than the duration of the video stream. Thus, a user would have to wait for encoding to complete in order to watch the video stream. In this case, it is still possible for a user to watch the video stream while it is being encoded, but a user would nevertheless have to wait for a certain “lead time” so that the slower encoding process may “compensate” for the faster playing of the video stream.

### SUMMARY OF THE INVENTION

The present invention is directed to a system and a method that encodes a single input media stream into two or more output media streams of different resolutions. The multiple output media streams may be used to display the media at multiple screens having different resolutions. Furthermore, one or more of the multiple output medial streams may be saved, so that if a consumer ever desires to play the media at a screen of a different resolution in the future, an encoded media stream for that resolution will be available and thus the consumer will not need to wait for the encoding to be performed.

Another aspect of the present invention is directed to system and a method that encodes a single input media stream into two or more output media streams having one or more different encoding characteristics. In one embodiment, one of the encoding characteristics which is different in the two or more output streams is the bandwidth of the encoding. In another embodiment, the different characteristic is the format of the encoding. In yet another embodiment the different characteristic is the computational complexity of the encoding. In a further development, computations that are common to the encoding process in each format may be found. The common computations may be performed only once. Once the common computations are performed in the context of encoding a media stream to a first format, the results of the common computations may be saved- and used for encoding the media stream in other formats.

Another aspect of the present invention system and method for encoding one or more media streams is provided. The system and method feature at least two modes of operation. In a first mode a single media stream is encoded in two or more different formats. In a second mode a first media stream is encoded, while a second media stream is simultaneously decoded.

### BRIEF DESCRIPTION OF THE DRAWINGS

FIG. 1 is a diagram of an example environment in which a preferred embodiment of the present invention may operate;

FIG. 2 is a diagram of an exemplary embodiment of the present invention;

FIG. 3 is a diagram of another exemplary embodiment of the invention and its operating environment;

FIG. 4 is a diagram showing motion compensation in accordance to an exemplary embodiment of the present invention, and

FIG. 5 is a diagram showing the timing of various embodiments of the present invention that take advantage of common computations.

### DETAILED DESCRIPTION OF THE PREFERRED EMBODIMENTS

The present invention is directed to encoding of media streams. The term encoding may refer to converting an analog stream into a digital stream, or alternatively receiving a digital stream in a first format and creating a stream of another format. The encoding of a media stream may also include compressing the stream. The format of a digital stream may refer to its encoding scheme (i.e. MPEG-2, etc) or other parameters of the encoding, i.e. in what resolution the stream is encoded.

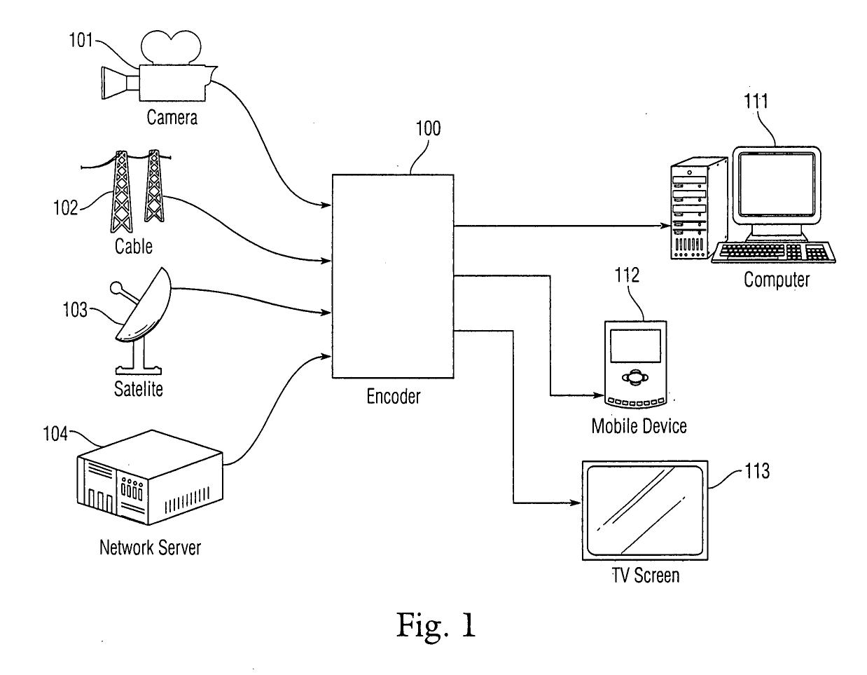

FIG. 1 is a diagram of an exemplary environment in which an exemplary embodiment of the present invention operates. The encoder 100 may receive a media stream from a plurality of sources such as, for example, a camera 101, a cable media provider 102, a satellite media provider 103, or a network server 104. The network server may be connected to the encoder through a local area network (LAN), a wide area network (WAN), a wireless network, or a global network such as the Internet.

The encoder may send an encoded signal to various receiving devices, such as for example, a TV screen 113, a mobile device 112, or a computer including a computer monitor 111. The encoder may be directly connected to the receiving devices, or alternatively, it may be connected to them through a network such as a LAN, WAN, a wireless network, or a global network such as the Internet.

The encoder 100 may determine which devices it must send an encoded signal to and subsequently encode the signal for the resolution (and in accordance with other characteristics) of that particular device. However, the present inventors recognized that sometimes an encoder needs to encode a signal for multiple sources. This is the case when one needs to view a particular media stream at multiple output devices.

For example, suppose a user lives in a multiform apartment or house which includes multiple television sets placed in different rooms. The user may wish to watch a certain media stream (e.g., a sports program) while performing other task which may require the user to move from room to room. Therefore, the user may wish to have all television sets play that particular program at the same time. However, the multiple television sets may be of different resolutions and may support different encoding formats.

Alternatively, one may wish to view a media stream at different devices at different times. For example, a user may access and view a program at a television set, but he/she may wish to be able to view the same program at a mobile device at some later time. This may be achieved by encoding the program multiple times by the encoder 100. However, this may result in multiple delays for the user. If the encoder requires some lead time to encode the program, the user would have to experience (i.e. wait) that lead time several times for each time the user plays the content at a different device.

Embodiments of the present invention solve this by providing an encoder that encodes a single media stream at different formats. The encoding at different formats is usually performed at substantially the same time. It may be done simultaneously (in parallel) or it may be done in an immediate succession.

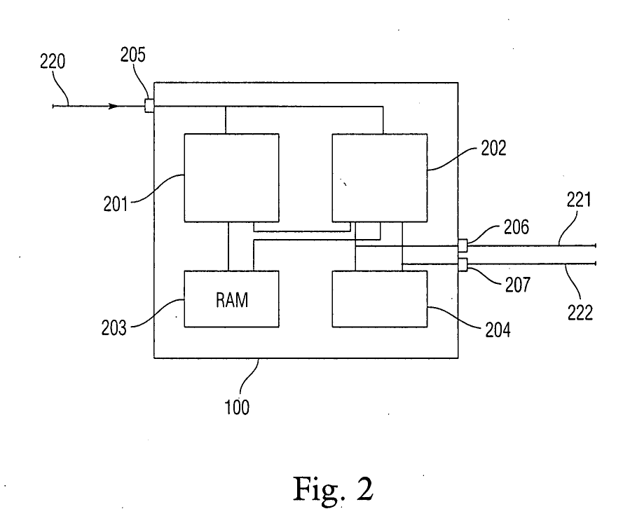

FIG. 2 is a diagram of an embodiment of the present invention. The encoder 100 includes two encoding units 201 and 202. The encoding units may be, for example ASICs or other chips which are designed to perform media encoding. The encoding units are preferably connected to a memory, such as RAM 203. The memory may store instructions for execution by the encoding units, or it may store various processing data needed by the encoding units to perform encoding. A non-volatile storage device, such as hard drive 204 may also be connected to the encoding units. The hard drive 204 may also store instructions and processing data. In addition, the hard drive may store entire encoded media streams.

Input port 205 is connected to an external connection 220 that allows a media stream to be sent to the encoder 100. Connection 220 may be connected, for example, to a digital network, such as for example, a LAN, WAN and the Internet. It may also be connected to a media provider, such as a cable service, or a satellite service, or to a device that produces a media output, such as, for example a DVD player. One or more output ports 206 and 207 are connected to one or more respective connections 221 and 222 through which one or more encoded media streams may be sent out to various devices. Connections 221 and 222 may be connected to various devices that receive media signals, such as, for example television sets, personal computers, mobile video devices. Connections 221 and 222 may also be connected to one or more digital networks.

During operation, a media stream may be sent from input port 205 to the two encoding units 201 and 202. The two encoding units then encode the media stream according in to different formats. The formats may differ in various aspects, as discussed above. For example, the two formats may be directed to different resolutions, different encoding methods, or different bandwidths. When encoding, the encoding units may use available storage, such as RAM 203, and hard-drive 204 to obtain machine executable instructions for the encoding, or to store and retrieve various processing data that is necessary for the encoding process.

The encoded streams may be sent out through output ports 206 and 207 connected to connections 221 and 222, respectively. Alternatively, one or both of the encoded media streams may be saved in the hard drive 204, so that it can be sent out at a later time if required.

For example, the present invention may be used in conjunction with a Television set and a mobile device. When a user wishes to watch a certain media stream on the television set, the encoder 100 of the present invention may encode the media stream into a first output stream for presentation at the television set and concurrently encode the same media stream into a second output stream for presentation at the mobile device. The two output streams would probably be encoded in different formats as the television set and the mobile device may have different display requirements. For example, the television set may feature a higher resolution than the mobile device, therefore the two media streams would be encoded to different resolutions. The second media stream (which is not being watched by the user) may be saved at the hard drive 204. Thus, if the user wishes to watch the same media (e.g., television show) at the mobile device, the saved media stream may be immediately forwarded to him/her and the user would be able to watch that media without waiting for any encoding delay.

Similarly, if the user initially requests to view the media at the mobile device, the encoding device 100 may encode the media stream into two output streams—one suitable for the portable device and one suitable for the television set. The output stream for the portable device is sent directly to the portable device, while the output stream for the television set is saved in, for example, hard drive 204. Thus, if the user wishes to watch the media again on the bigger television screen, he/she can request it without having to wait for it to be encoded.

While the herein described embodiments of the present invention are directed to encoding, it should be understood that many encoders may also be used as decoders. Most media encoding schemes are designed to rely on easily reversible mathematical formulas. Thus, the computer hardware used for encoding for many of these formats may usually also be used for decoding. In certain cases, decoding requires that specific software directed towards the decoding function be used as well. Therefore, embodiments of the present invention may allow that the encoding units be also used as decoding units, and thus the encoder 100 may also serve as a decoder. More specifically, the encoder may have different modes of operation, wherein in some modes one or more of the encoding units may be operating as decoder units.

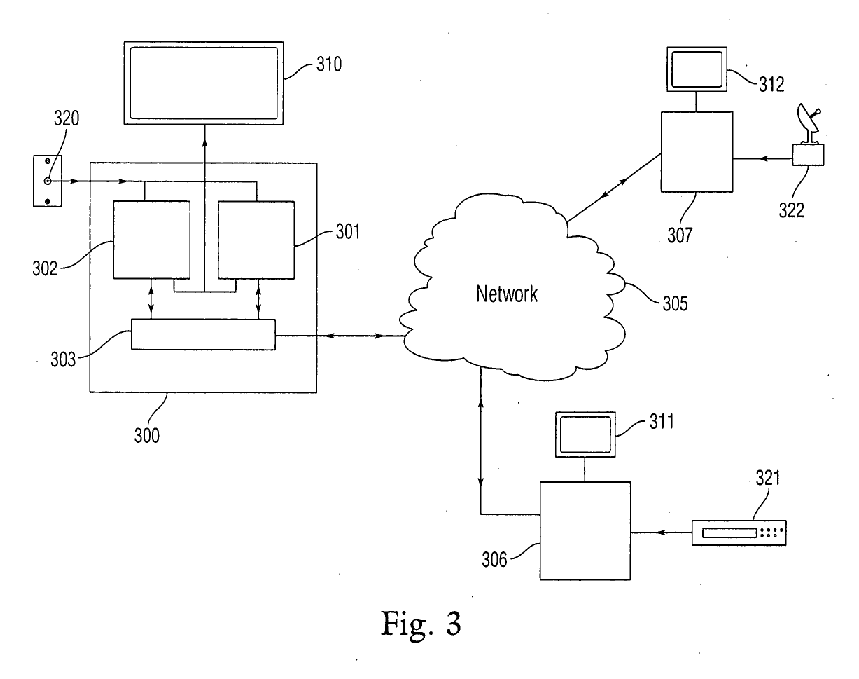

FIG. 3 shows an embodiment of the present invention in which the encoding units feature dual mode operation as discussed above. Here, the encoder/decoder 300 is used instead of an encoder. The encoder/decoder 300 includes to encoding/decoding units 301 and 302. The encoding/decoding units may more generally be referred to as types of processors. Each of these units is capable of encoding a video signal as well as decoding it. A network interface 303 is also included. The encoder decoder 300 is connected to a video signal source such as cable television 320, as well as a video output device such as television screen 310.

The encoder/decoder 300 is connected to a network 305. Additional encoder/decoders, such as encoder decoders 306 and 307 are also connected to the network. The additional encoder/decoders may also be connected to video signal sources, such as DVD player 321 and satellite TV antenna 322. Furthermore, the additional encoder/decoders may also be connected to video output devices, such as Television screens 311 and 312.

The encoder/decoder of the present invention may operate in several different modes. In one mode (referred to as the encode/decode mode), it can receive a signal from the video signal source 320, encode that signal by using one of the encoding/decoding units (for example, 302) and send the encoded signal over the network to another encoder/decoder (for example, encoder decoder 307). At the same time the other encoding/decoding unit 301 may receive a signal from another encoder/decoder (e.g., encoder/decoder 307) and decode that signal to produce a video stream suitable for TV set 310. Decoder/encoder 307 may operate in a similar manner to encode a signal received from antenna 322 and send it to encoder/decoder 300 while at the same time decode the signal being received from encoder decoder 300.

Thus, the present embodiment may allow the usual video signal sources of a residence to be simultaneously accessed at different locations. In other words, the present embodiment may allow TV set 310 to display a video signal associated with satellite antenna 322, while TV set 312 displays a video signal associated with cable TV service 320, regardless of the fact that TV set 310 is in proximity to the cable plug 320, while TV set 312 is in proximity to the satellite service. A person of skill in the art would readily recognize that the present embodiment may allow for various different combinations of incoming and outgoing signals in addition to the ones discussed above.

In the above discussed encode/decode mode, one of the encoding/decoding units was used as an encoder and the other one as a decoder. The present embodiment is also capable of being used in another mode (referred to as multiple encode mode) in which both encoding/decoding units are used as encoders. In this mode, as discussed above with reference to different embodiments, both encode decode units are used at the same time to encode a single video signal into two encoded signals having different characteristics. As discussed above, the different characteristics may include different resolutions, bandwidths, encoding formats, etc. Thus, one encoded stream may be displayed at TV set 310, while the other may be sent over the network to be displayed at another output device, or it may be stored.

It is an advantage of this particular embodiment of the present invention that the encoder/decoder 300 may switch between these two modes as the need arises. Thus, by flexibly utilizing the encoder/decoder 300 hardware resources (i.e. encoding/decoding units 301 and 302) the present embodiment provides two different useful features without requiring too much extraneous hardware.

In the previously discussed embodiments, two or more encoding units usually encode the signal independently of each other in two or more different formats. In an alternative embodiment, the various encoding units may share information in order to improve efficiency and avoid redundant computations. Encoding the same video stream in multiple formats often requires that different computations be performed for the different formats. However, certain intermediate computations may be the same for the different formats. Such computations will be referred to as common computations hereafter. In an embodiment of the present invention, such common computations may be identified and two or more encoding units may communicate with each other so that one unit which has performed said common computations may send the results to one or more other units, allowing the other units to use these results without performing the computations themselves. For example, with reference to FIG. 2, encoding unit 201 may perform certain common computations and send these computations to encoding unit 202.

In one embodiment, the timing of encoding operations of the two or more encoding units may be staggered in order to allow a first encoding unit to perform the common computations and the other encoding units to utilize the results. Thus, the other encoding units may initiate encoding a certain time after the first encoding unit does so that they can use the results of the common computations performed by the first encoding unit.

Alternatively, the other encoding units may stop operation to wait for the results. In another alternative, the various encoding units may have the order of computations to be performed in a specified order so that the other encoding units will be able to use the results of the common computations when the first encoding unit provides them.

In another embodiment, the first encoding unit features higher computational power than the other encoding units. Thus, the first encoding unit may perform the common operations quicker. As the other encoding units may not perform the common operations but use the results provided by the first encoding unit, their lower computational power may not result in a significant decrease in performance. Alternatively, the first encoding unit may feature additional hardware dedicated to performing the common computations.

The above discussed features may be incorporated in the two mode embodiments of the present invention (i.e., the embodiments that may perform encoding and/or decoding as shown by FIG. 3). Thus, the embodiment of FIG. 3 may be modified so that, when the system operates in multiple encode mode, one of the encoder units (for example, encoder/decoder 301) performs common computations while the other one (for example, encoder/decoder 302) does not. In a further development, the encoder/decoder 301 that performs the common computations may be modified so that it only performs encoding, and may be provided with higher computational ability. The encoder/decoder 302, on the other hand would be provided with lower computational ability and perform encoding or decoding depending on the mode of operation of the system. This embodiment is based on the assumption that decoding and encoding without performing the common computations requires less computation than encoding while performing the common computations. Therefore, to improve efficiency, the encoder that performs the common computations is provided with higher computational ability than the encoder/decoder that either decodes or encodes without performing the common computations.

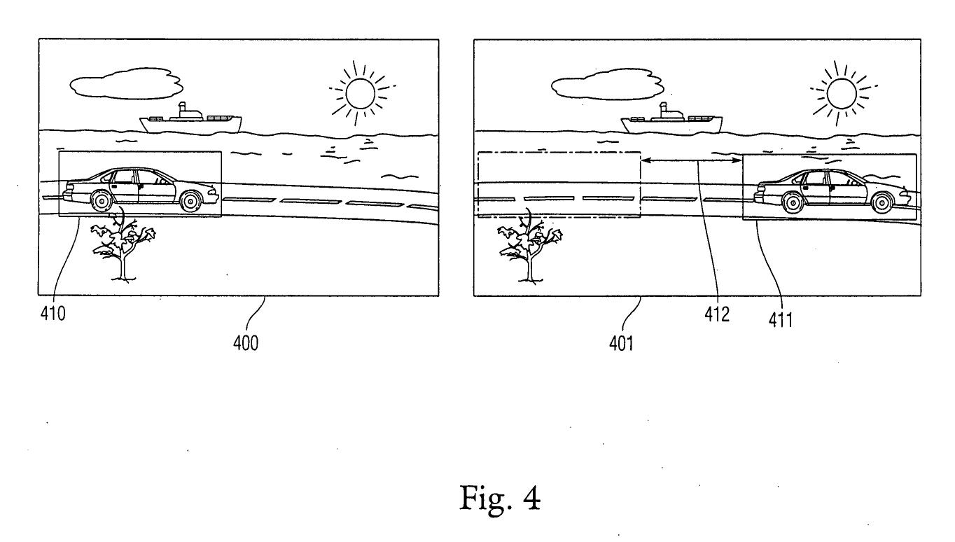

A person of skill in the art would recognize that there are many other possible variations of common computations depending on the encoding schemes being used. FIG. 4 shows one such example of common computations.

Most existing video encoding schemes (e.g. MPEG) use motion estimation and compensation to compress video data. Motion compensation relies on the fact that often a frame of a video stream is very similar to the ones preceding or following it, but includes differences in terms of objects that may have changed their position. For example, frame 400 is similar to frame 401 except for the difference that the car has moved from the left side of frame 400 to the right side of frame 401. The car is part of image blocks 410 and 411 of frames 400 and 401 respectively.

Encoding schemes employing motion compensation provide that block 411 of image 401 is not is not independently encoded but defined with reference to block 410 of image 400. Thus, block 411 is defined by a reference to block 410. A vector 412 which indicates the positional difference between block 410 and block 411 and a plurality of difference data which may define any image specific differences between block 411 and 410 (e.g. the car of block 411 may have slightly different coloration than the one of block 410 due to different shadows, etc). Since the same car is pictured in the two blocks, it is hoped that the differences between the two blocks will be minor and thus block 411 may be defined by a small amount of data.

Motion compensation provides great benefits in terms of compression but it requires a high amount of computation during encoding. In order to perform perfect motion compensation, the encoder must examine each block of each frame and compare it with each block of a plurality of subsequent or previous frames in order to find similar block pairs (such as blocks 410 and 411) that may be used as the basis for motion compensation. This is very costly in terms of computational requirements. Some encoding tools use complex algorithms that aim to reduce the numbers of blocks which are to be compared. However, even these algorithms create relatively large computational loads.

It is noted that the task of identifying similar blocks depends greatly on the substance of the video stream and not on particular encoding formats. In other words, it is the actual visual objects that are shown in the video stream that are crucial in this task. Therefore, this task may be performed and would yield similar results for different encoding schemes. Thus, it may be used as common computational operations.

It is true that different encoding schemes may use different block organizations, so that blocks 410 and 411 may be a single block each in one encoding scheme, while being represented by four blocks each in another. However, the task of finding similar objects in several subsequent frames and detecting their movement may be easily abstracted so that it does not depend on a particular encoding scheme's implementation of blocks.

Therefore, an embodiment of the present invention uses the task of identifying similar image portions in temporarily related frames for the purposes of motion compensation enabled encoding as the common computation discussed above.

In an alternative embodiment of the present invention, a single processor is used to encode a media stream in two different formats. Initially, the media stream is encoded in a first format. While encoding the media stream in the first format, common computations are performed and their results are stored. Subsequently, the media stream is encoded in a second format. While the media stream is being recorded in the second format, the common computations are not repeated, but instead the previously stored results are used.

The common computations may involve the identifying of similar image portions in temporally related frames for the purposes of motion compensation as discussed above.

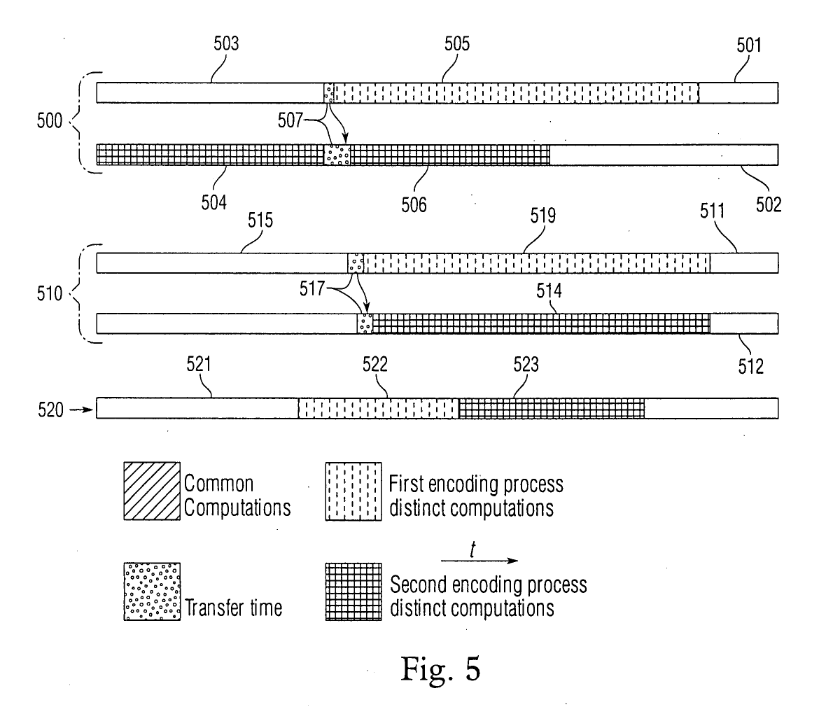

FIG. 5 is a diagram showing the timing of various embodiments of the present invention that take advantage of common computations. FIG. 5 includes several graphs in which the passage of time is represented in the x axis as shown.

In a first embodiment, which is described by graph 500, two encoders are used. The timing of each encoder is represented by bars 501 and 502 respectively. The two processors may perform common or distinct computations, as shown in FIG. 5. Common computations are computations which must be performed by both processors in order to encode an incoming media signal in two different formats. Distinct computations are computations which are different for each processor. The first processor (associated with line 501) performs common operations 503 in the beginning. Meanwhile, the second processor (associated with line 502) performs distinct operations 504. When the first processor finishes performing the common computations, it transfers (507) the results to the second processor. The first processor then proceeds to perform distinct computations 505, utilizing the results of the common computations. The second processor receives the results of the common computations and proceeds to perform another set of distinct computations 506, while also utilizing the results of the common computations.

Another embodiment of the present invention is represented by graph 510. Here, the first processor is represented by bar 511, while the second one is represented by bar 512. The first processor performs the common computations 515. Meanwhile, the second processor does nothing (or alternatively, processes another media stream or portion thereof). The first processor then transfers (517) the common computations to the second processor. The first and second processors then perform their respective distinct computations (519 and 514, respectively) based on the results of the common computations. In this embodiment, it may be beneficial that the first processor be designed to feature higher computational power, so that the waiting time of the second processor may be minimized.

Another embodiment of the present invention is represented by graph 520. In this embodiment a single processor performs the two encoding processes. In other words, a single processor encodes the stream in first and second formats. The single processor may first perform the common computations 521. Subsequently, it may perform distinct computations associated with a first encoding process. It may then perform distinct computations associated with the second encoding process.

It should be noted that the timing diagrams of FIG. 5 are not intended to be precise measurements of actual timing, but broader conceptual overviews of the high level design of the illustrated embodiments. Alternative embodiments may have different timing—for example the common computations of lines 501, 511, and 520 may be preceded by distinct computations.

Examples of various groups of different formats in which the present invention may encode a single media stream are: two different resolutions of a single encoding format, such as MPEG 2 in 800×600 resolution and MPEG 2 in 1280×1024 resolution; two different encoding formats, such as MPEG 2 and AVI (thus varying resolution, encoding complexity and bandwidth), two different levels of a single encoding format, such as level 2 and level 4 of the MPEG 4 AVC format (varying bandwidth, complexity, resolution, etc.), two different profiles of a single level of the MPEG 4 AVC format, etc. A person of skill in the art would recognize that many combinations may be formed from the multitude of existing formats, and various levels, versions, or resolutions of each format.

While the above discussed examples generally referred to embodiments of the present invention in which the incoming media stream is encoded into two different formats, persons of skill in the art would recognize that the present invention may be practiced by encoding the media stream in three or more different formats.

Furthermore, embodiments of the present invention may also encode audio in different formats. An audio stream may be encoded together with a corresponding video stream, or alternatively, audio streams may be individually encoded in different formats. Examples of various audio formats that may be used are MP3, AVI, Ogg Vorbis, etc. Also, different sub-types of the same format may be used. For example, the MP3 format is available in several different bandwidths (also known as bit-rates). Thus, the present invention may encode the same audio stream in two encoded streams according to two different bit-rates of the MP3 format. Generally, the different formats may have different audio resolution, bandwidth, compression complexity, etc.

One skilled in the art may devise many alternative configurations for the systems and methods disclosed herein. It should be understood that the present invention may be embodied in many other specific forms without departing from the spirit or scope of the invention and that the present examples are to be considered as illustrative and not restrictive. Thus, the invention is not to be limited to the details given herein. It may encompass any embodiments within the scope of the claims below.

We claim:

1. A system comprising:
an input port for receiving an incoming media stream;
a first encoder, configured to encode the incoming media stream in a first format to produce a first outgoing media stream; and
a second encoder configured to encode the incoming media stream in a second format to produce a second outgoing media stream, while the first encoder is encoding the incoming media stream in the first format,
wherein the first and second formats differ.

2. The system of claim 1, wherein the media stream is a video stream.

3. The system of claim 2, wherein the first and second formats differ in their resolution.

4. The system of claim 2, wherein the first and second encoders further compress the media stream as part of encoding it.

5. The system of claim 4, wherein the first and second formats differ in their bandwidth.

6. The system of claim 4, wherein the first and second formats differ in the complexity of their respective encoding and decoding algorithms.

7. The system of claim 1, further comprising an output port for sending the first outgoing media stream to a first output device and the second outgoing media stream to a second output device, wherein the first and second formats are associated with the first and second output devices, respectively.

8. The system of claim 7, wherein the first and second output devices are video monitors having different native resolutions, and the first and second formats are specific to the native resolutions of the first and second output devices, respectively.

9. The system of claim 8, wherein the first output device is a television set, and the second output device is a portable video device.

10. The system of claim 1, further comprising a storage device, wherein the storage device stores at least one of the media streams.

11. The system of claim 1, further comprising a network adapter for sending at least one of the outgoing media streams to an output device over a network.

12. The system of claim 1, wherein the incoming media stream is an audio stream.

13. The system of claim 1, wherein the first encoder performs a plurality of common computations to obtain a plurality of common results as part of encoding the incoming media stream, and sends the common results to the second encoder, and wherein the second encoder utilizes the common results as part of encoding the incoming media stream in the second format without performing the common computations.

14. The system of claim 14, wherein the common computations comprise the finding of similar image portions in temporally related flames for the purposes of motion compensation.

15. A system comprising:
one or more input ports for receiving one or more incoming media streams;
one or more output ports for sending one or more outgoing media streams;
a first processor having at least an encode mode of operation;
a second processor having an encode and a decode mode of operation;
wherein the system has at least two modes of operation comprising:
a first mode of operation in which the first and second processors operate in encode mode to simultaneously encode a first incoming media stream into two respective outgoing media streams having first and second formats respectively, the first and second formats being distinct;
a second mode of operation in which the first processor operates in encode mode and encodes a second incoming media stream, and the second processor operates in a decode mode and simultaneously decodes a third incoming media stream.

16. A method for encoding a media stream comprising the steps of:
receiving an incoming media stream;
encoding the incoming media stream in a first format at a first encoder to produce a first outgoing media stream; and
encoding the incoming media stream in a second format by a second encoder to produce a second outgoing media stream, while the first encoder is encoding the incoming media stream in the first format,
wherein the first and second formats differ.

17. The method of claim 16, wherein the media stream is a video stream.

18. The method of claim 17, wherein the first and second formats differ in their resolution.

19. The method of claim 18, wherein the two steps of encoding the media stream each further comprise the step of compressing the media stream.

20. The method of claim 19, wherein the first and second formats differ in their bandwidth.

21. The method of claim 19, wherein the first and second formats differ in the complexity of their respective encoding and decoding algorithms.

22. The method of claim 16, further comprising the steps of:
sending the first outgoing media stream to a first output device; and
sending the second outgoing media stream to a second output device,
wherein the first and second formats are associated with the first and second output devices, respectively.

23. The system of claim 22, wherein the first and second output devices are video monitors having different native resolutions, and the first and second formats are specific to the native resolutions of the first and second output devices.

24. The method of claim 23, wherein the first output device is a television set, and the second output device is a portable video device.

25. The method of claim 16, further comprising the step of storing at least one of the media streams at a storage device.

26. The method of claim 16, further comprising the step of sending at least one of the outgoing media streams to an output device over a network.

27. The method of claim 16, wherein the incoming media stream is an audio stream.

28. The method of claim 16, wherein:
the step of encoding the incoming media stream in a first format at a first encoder further comprises performing a plurality of common computations to obtain a plurality of common results; and sending the common results to the second encoder; and
encoding the incoming media stream in a second format at a second encoder comprises utilizing the common results to encode the incoming media stream in the second format without performing the common computations.

29. The method of claim 28, wherein the common computations comprise the finding of similar image portions in temporally related frames for the purposes of motion compensation.

30. A method for encoding and decoding one or more media streams at a device comprising a first and second processors, the method comprising:
setting the device to a first mode;
encoding a first incoming media stream of the one or more media streams by the first processor in a first format to produce a first outgoing media stream;
encoding the first incoming media stream by the second processor in a second format to produce a second outgoing media stream, the step being performed simultaneously with the encoding a first incoming media stream by the first processor step, and the first and second formats being distinct;
setting the device to a second mode;
setting the second processor to a decode mode;
encoding a second incoming media stream of the one or more media streams by the first processor in a first format to produce a first outgoing media stream; and
decoding a third incoming media stream by the second processor to produce a second outgoing media stream, this step being performed simultaneously with the encoding a second incoming media stream by the first processor step.
